(19) United States
(12) Patent Application Publication
(10) Pub. No.: US 2011/0254304 A1
(43) Pub. Date: Oct. 20, 2011

(54) RECREATIONAL VEHICLE KITCHEN BLOCK

(75) Inventor: Paolo Moresco, Bassano del Grappa (VI) (IT)

(73) Assignee: DOMETIC GMBH, Siegen (DE)

(21) Appl. No.: 13/061,272

(22) PCT Filed: Aug. 31, 2009
(86) PCT No.: PCT/EP2009/006282

§ 371 Date: Jun. 8, 2011

(30) Foreign Application Priority Data
Aug. 29, 2008 (DE) 10 2008 044 898.2

(51) Int. Cl. B60N 3/16

(52) U.S. Cl. 296/24.4

(57) ABSTRACT

The instant invention relates to a recreational vehicle kitchen block (1) comprising a functional area (2), which encompasses at least one sink (9) and/or a hob (18). According to the invention, the functional area (2) is characterized in that it encompasses a functional module (3, 4), the plan view of which is designed so as to be rectangular, and the length of which is twice as large as its width and in which the sink (9) and/or the hob (18) is arranged.

The instant invention relates to a recreational vehicle kitchen block comprising a functional area, which encompasses at least one sink and/or a hob. Recreational vehicle is to refer herein to a travel trailer, caravan, sport boat or the like. According to this, it is a kitchen block, which is set up in the case of confined room conditions.

The term kitchen block stands herein for kitchen furniture, in which mainly the functional core elements of a kitchen are housed. As a rule, these are a sink and/or a hob. For the most part, such a kitchen block encompasses a support construction for accommodating and fastening the functional core elements. As a rule, this support construction is covered towards the top by means of a work top.

Due to the spatial constriction in a recreational vehicle, there is typically a demand for constructing a recreational vehicle kitchen block to be as space-saving as possible, and thus in a mostly individually adapted manner. At the same time, there is an increasing demand for not only being able to install a kitchen block into a recreational vehicle, if possible, but to design it as flexible as possible, so as to be able to install it in different recreational vehicles with as few changes as possible.

The invention is thus based on the object of creating a recreational vehicle kitchen block, which optimally utilizes the space and room conditions in a recreational vehicle and which can, at the same time, be flexibly adapted to different installation requirements.

The solution of the object can be attained by means of the recreational vehicle kitchen block according to claim 1. Advantageous developments are specified in the subclaims.

It is thus a recreational vehicle kitchen block comprising a functional area, which encompasses at least one sink and/or a hob, wherein the functional area encompasses at least one functional module, the plan view of which is designed so as to be rectangular, and the length of which is twice as large as its width and in which the sink and/or the hob is arranged. This specific length to width ratio of 2:1 provides for the systematic joining of individual functional modules like dominos. For example, the narrow sides of two modules can be arranged on the longitudinal side of another module without hereby causing gaps or openings between the functional modules. It thus makes sense for the modules to not only have a rectangular cross section, but to be designed so as to be cuboidal.

At the same time, the defined and standardized shaping of the functional modules also provides for the easy replacement of a functional module with another one. The kitchen block according to the invention can thus easily be adapted to the most versatile installation requirements and can be easily remodeled.

It is thus basically possible for the functional area to only encompass a single functional module. Preferably, the functional area, however, encompasses a plurality of functional modules. These can be placed directly next to one another with the same orientation, for example. However, it is also possible for individual modules to be arranged so as to be rotated by 90° to one another. Two modules can then be placed on the longitudinal side of a third module, for example. It goes without saying that more than two or three functional modules can be combined with one another as well.

Advantageously, a functional module encompasses a sink comprising a preferably rectangular plan view. It makes sense for this sink functional module, in turn, to encompass a faucet, the outlet of which is preferably embodied so as to be capable of being lowered, retracted, folded away and/or unscrewed. Completely pre-assembled functional modules can thus be created. They are installed into the functional area of the recreational vehicle kitchen block as complete functional unit in response to the interior construction of the recreational vehicle. The locally adapted assembly of the faucet on location is thus no longer necessary. Instead, only the support construction of the kitchen block must be adapted to the recreational vehicle. This makes it possible for the manufacturers of recreational vehicles to assemble the kitchen block quickly and simply or to also adapt it to client requests or requirements, respectively, which were changed on short notice. Only one functional module must then be replaced with another functional module for this purpose.

In a further development, the sink of the sink functional module encompasses a bracket for a cutting board or a drain tub. It makes sense for these inserts to only partly cover the sink. In addition, these inserts are preferably held in the bracket so as to be displaceable in the longitudinal direction of the module. For instance, the cutting board can remain inserted in the sink in response to the corresponding design of the faucet and the faucet can still be operated. By displacing the cutting board, the user can also freely place the gap where it is most advantageously positioned for its respective use.

In a further development, a functional module encompasses a hob comprising two cooking zones. The hob can consist of glass ceramics, stainless steel or the like. The cooking zones can be operated with electricity, gas, kerosene or the like.

It also makes sense for a functional module to encompass a hob comprising only a single cooking zone. It is particularly advantageous when this individual cooking zone is oriented in the center with reference to the cooking zones of an adjacently arranged two cooking zone functional module. For instance, a relatively large-surface cooking container, such as a frying pan, for example, which projects beyond the edge of the functional module, can be used without obstructing the use of the adjacent two cooking zone functional module.

In a further development, a cooking zone functional module encompasses a pot grate, which is preferably height-adjustable. This pot grate serves to set up a pot above the cooking zone, which is advantageous in particular in the case of gas-operated cooking zones.

In a further development, the control buttons arranged on the upper side of a functional module are embodied so as to be capable of being lowered. This can make sense in particular when a cover plate is to be placed onto the upper side of the functional module.

In a further development, a functional module encompasses a drip zone, which is preferably designed as a tub comprising a rectangular plan view. Preferably, a bracket for a removable holder for dishes and/or flatware is then arranged in the area of the drip zone.

Advantageously, one functional module, preferably each functional module, encompasses a plate-shaped cover. This can be used as work top, e.g. In a further development, the plate-shaped cover consists of glass, thus resulting in an overall pleasant appearance.

With reference to the sink functional module, it makes sense for the plate-shaped cover to consist of two individual plates, which are arranged so as to movable relative to one another. The first individual plate is thereby preferably embodied so as to be capable of being folded into a cut-out of the second individual plate. The second individual plate can thus already be placed onto the sink, without the need to fold away the faucet. In the event that a uniform work top is to be created, the faucet is folded inwardly or the outlet thereof is unscrewed, respectively, and the first cover plate is folded into the cut-out of the second cover plate.

As a whole, it makes sense for the functional area to be framed by a continuous work top or to be arranged so as to lay on it. For instance, the work top can be used to hold the functional area.

The invention will be explained in more detail below by means of exemplary embodiments, which are shown in the figures. Schematically,

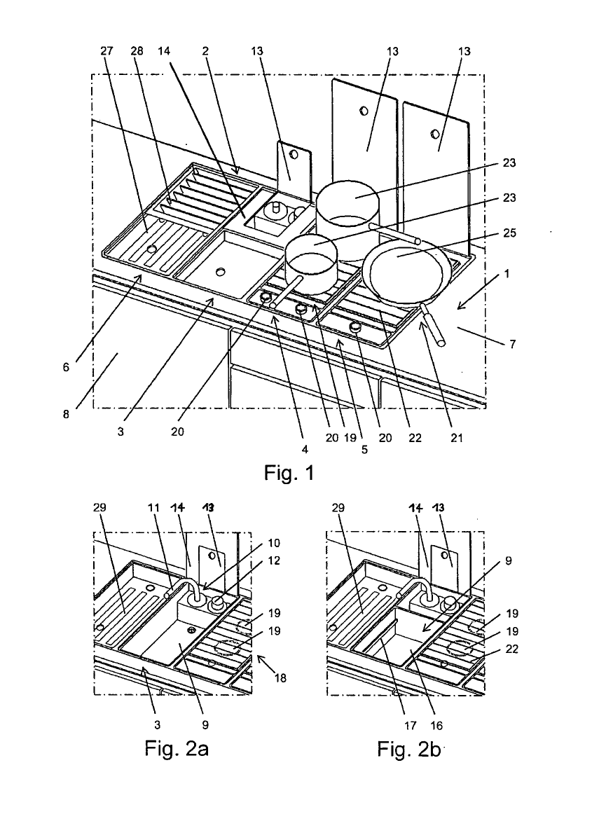

FIG. 1 shows a partially spatial illustration of a first exemplary embodiment of a recreational vehicle kitchen block according to the invention;

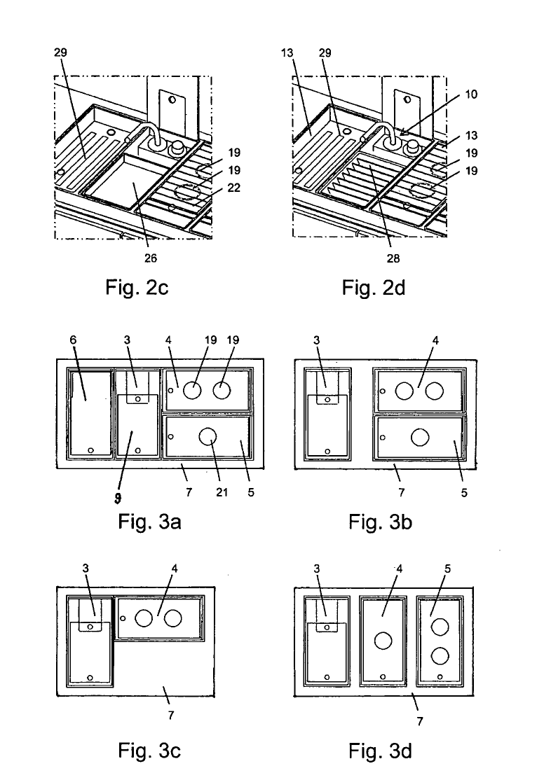

FIG. 2 shows four partially spatial illustrations of the first exemplary embodiment shown in FIG. 1 of the recreational vehicle kitchen block without and with different inserts in the sink;

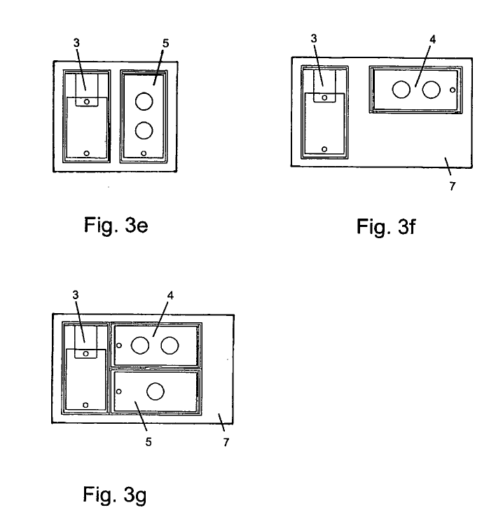

FIG. 3 shows plan views for seven different arrangements of the functional modules.

A first exemplary embodiment of a recreational vehicle kitchen block 1 according to the invention is partially shown in FIG. 1. It encompasses a functional area 2 as well as four functional modules 3, 4, 5 and 6, which are arranged therein. The functional area 2 is recessed into a work top 7, which in turn is fastened to a substructure 8. The substructure 8 thus supports the functional area 2 and the functional modules 3, 4, 5 and 6, which are arranged therein.

As can be seen from FIGS. 1 and 2, the sink functional module 3 encompasses a sink 9, which has a rectangular plan view. The sink functional module 3 further encompasses a faucet 10 comprising an outlet 11, which can be sunk, and a valve actuating knob 12, which is arranged next to it. The outlet 11 and the actuating knob 12 of the faucet 10 are arranged next to one another on one level in the washing tub 9. The sink functional module 3 furthermore encompasses a cover plate 13, which is arranged in a cut-out of a second cover plate 14. For instance, the smaller cover plate 13, which is articulated in the area of the faucet 10, can be folded into the cut-out of the second cover plate 14 when the outlet 11 of the faucet 10, which can be retracted or extended, is in the extended position. In the event that the faucet outlet 11 is in its functional position, as is shown in FIG. 1, the first cover plate 13 is folded upwards, while the second cover plate 14 rests on the sink and covers it. In FIG. 2, both cover plates are open so as to unblock the entire sink 9.

As is shown in FIGS. 2a, 2c and 2d, different inserts 15 can be inserted into the sink 9. In FIG. 2a, an insert 15 is not inserted, so that the sink 9 can be seen by itself therein. In FIG. 2b, a rectangular tub 16 is inserted. This tub encompasses two lateral guide rails 17, onto which a flat drip tub 26 is attached in FIG. 2c. In FIG. 2d, a drip bracket 28 is attached onto the drip tub 26.

The exemplary embodiment shown in FIGS. 1 and 2 further encompasses a functional area 2 comprising a two cooking zone functional module 4. It has a hob 18 comprising two cooking zones 19. Both cooking zones 19 can in each case be controlled separately via a turn knob 20. The functional module 4 furthermore encompasses a pot grate 22. For instance, two pots 23 can be set up on the functional module 4, as is shown in FIG. 1, and can be heated separately form one another. The functional module 4 furthermore also encompasses a cover plate 13 of dark-colored glass. At its front face, this cover plate 13 is articulated on the functional module 4 by means of a hinge, which is not illustrated in detail herein. When the pots 23 are removed, the cover plate 13 can thus be placed onto the cooking zone functional module 4. As is shown in FIG. 2, this results in a work surface, which is flush with the work top 7.

In FIG. 1, a one cooking zone functional module 5 is arranged directly adjacent to the right of the two cooking zone functional module 4. This functional module 5 encompasses a hob 18 comprising only one cooking zone 21, which can be controlled by means of a control button 19. Just like the control buttons 19 of the functional module 4, the control button 19 of the functional module 5 can also be lowered so as to also be able to fold a cover plate 13 made of glass onto the functional module 5.

As can be seen from FIG. 1, the situation in the case of the exemplary embodiment illustrated herein is now such that the cooking zone 21 is oriented centrally to the two cooking zones 19 of the two cooking zone functional module 4. This has the advantage that, as can be seen from FIG. 1, a frying pan 25 extending beyond the functional module 5 can generally be set up between the pots 21, thus obtaining an optimal utilization of space.

The kitchen block 1 furthermore encompasses a drip functional module 6, which substantially consists of a flat and rectangular drip tub 29. In FIG. 1, a holder for dishes 28 is attached to the upper edge of the drip tub 29. In FIG. 1, a cutting board 27 made of glass is inserted next to the holder for dishes 28, while a large-surface cover plate 13 made of glass is placed onto the tub 29 in FIG. 2.

FIGS. 3a to 3g illustrate the plan views for seven different arrangement examples of the functional modules 3, 4, 5, 6. FIG. 3a thereby shows an alternative, which has a slightly modified orientation as compared to the arrangement shown in FIG. 1. Just like in the case of the arrangement according to FIG. 1, a drip functional module 6 is arranged to the left of the sink functional module 3. The cooking zone functional modules 4 and 5, however, are oriented to the right of the sink functional module 3 so as to be oriented crosswise to it. In other words, the modules 4 and 5 are rotated at 90 degrees.

FIG. 3b shows an alternative, in the case of which the two functional modules 4 and 5 are oriented so as to be spaced apart to the functional module 3. In FIG. 3c, only a two cooking zone functional module 4 is arranged next to a sink functional module 3. In FIG. 3d, the individual functional modules 3, 4 and 5 are assembled in the work top 7 so as to be pulled apart from one another. The arrangement according to FIG. 3e is similar as well, wherein a one cooking zone functional module was foregone herein. The same applies to the arrangement according to FIG. 3f, wherein, as compared to FIG. 3e, the two cooking zone functional module 4 was rotated herein by 90 degrees relative to the sink functional module 3.

FIG. 3g shows an alternative of the arrangement according to FIG. 3a, in the case of which the drip functional module 6 was foregone. All of the alternatives in FIG. 3a show that the kitchen block according to the invention is characterized in that the functional area 2 can be adapted to different installation requirements in a recreational vehicle in a highly flexible and variable manner by means of the functional modules 3, 4, 5, 6, which are designed with a length to width ratio of 2:1. The grid thus provides for most versatile orientations and variations of functional area 2, thus resulting in a proper kitchen system, by means of which an individually adapted kitchen block 1 can be produced without much effort.

1. A recreational vehicle kitchen block (1) comprising a functional area (2), which encompasses at least one sink (9) and/or a hob (10),
characterized in that
the functional area (2) encompasses at least one functional module (3; 4), the plan view of which is designed so as to be rectangular and the length of which is twice as large as its width and in which the sink (9) and/or the hob (10) is arranged.

2. The recreational vehicle kitchen block according to claim 1,
characterized in that
the functional area (2) encompasses an individual functional module (3; 4).

3. The recreational vehicle kitchen block according to claim 1,
characterized in that
the functional area (2) encompasses a plurality of functional modules (3, 4).

4. The recreational vehicle kitchen block according to one of the preceding claims,
characterized in that
a functional module (3) encompasses a sink (9) comprising a preferably rectangular plan view.

5. The recreational vehicle kitchen block according to claim 4,
characterized in that
the sink functional module (3) encompasses a faucet, the outlet (11) of which is preferably embodied so as to be capable of being lowered, retracted, folded away and/or unscrewed.

6. The recreational vehicle kitchen block according to claim 4 or 5,
characterized in that
the sink (9) of the sink functional module (3) encompasses a bracket for an insert (15), which covers the sink (9).

7. The recreational vehicle kitchen block according to claim 4,
characterized in that
the insert (15) only partially covers the sink (9) and is preferably held in the bracket so as to be displaceable in the longitudinal direction of the module (3).

8. The recreational vehicle kitchen block according to one of the preceding claims,
characterized in that
a functional module (4) encompasses a hob (18) comprising two cooking zones (19).

9. The recreational vehicle kitchen block according to one of the preceding claims,
characterized in that
a functional module (5) encompasses a hob (18) comprising a single cooking zone (21).

10. The recreational vehicle kitchen block according to one of claims 6 and 7,
characterized in that
the cooking zone (21) is oriented centrally with reference to the cooking zones (19) of an adjacently arranged two cooking zone functional module (4).

11. The recreational vehicle kitchen block according to one of the preceding claims,
characterized in that
a cooking zone functional module (4, 5) encompasses a pot grate (22), which is preferably height-adjustable.

12. The recreational vehicle kitchen block according to one of the preceding claims,
characterized in that
control buttons (20), which are arranged at the upper side of a functional module (3, 4, 5, 6), are embodied so as to be capable of being lowered.

13. The recreational vehicle kitchen block according to one of the preceding claims,
characterized in that
a functional module (6) encompasses a drip zone, which is preferably embodied as drip tub (29).

14. The recreational vehicle kitchen block according to claim 9,
characterized in that
a bracket for a removable holder for dishes and/or flatware (28) is arranged in the area of the drip zone (29).

15. The recreational vehicle kitchen block according to one of the preceding claims,
characterized in that
at least one functional module (3, 4, 5, 6), preferably each functional module, encompasses a plate-shaped cover (13).

16. The recreational vehicle kitchen block according to claim 12,
characterized in that
the plate-shaped cover (13) consists of glass.

17. The recreational vehicle kitchen block according to one of claim 12 or 13,
characterized in that
the plate-shaped cover of the sink functional module (3) consists of two individual plates (13, 14), which are arranged so as to be movable relative to one another, wherein the first individual plate (13) can preferably be folded into a cut-out of the second individual plate (14).

18. The recreational vehicle kitchen block according to one of the preceding claims,
characterized in that
the functional area (2) is framed by a continuous work top (7) or is arranged so as to lay on it.
